(19) United States
(12) Patent Application Publication
(10) Pub. No.: US 2017/0285210 A1
(43) Pub. Date: Oct. 5, 2017

(54) PORTABLE METAL DETECTOR

(71) Applicant: Costruzioni Elettroniche Industriali Automatismi S.p.A. C.E.I.A. S.P.A, Arezzo (IT)

(72) Inventor: Alessandro Manneschi, Arezzo (IT)

(73) Assignee: Costruzioni Elettroniche Industriali Automatismi S .p.A. C.E.I.A. S.P.A., Arezzo (IT)

(21) Appl. No.: 15/493,716

(22) Filed: Apr. 21, 2017

Related U.S. Application Data
(63) Continuation-in-part of application No. 14/451,799, filed on Aug. 5, 2014, now abandoned.

(30) Foreign Application Priority Data
Aug. 5, 2013 (FR) 1357790

(51) Int. Cl. G01V 3/08; G01S 13/88; G01V 3/15; G01V 3/10; G01P 15/18

(52) U.S. Cl. CPC G01V 3/081; G01V 3/105; G01P 15/18; G01V 3/15; G01S 13/887

(57) ABSTRACT

The present invention relates to a portable metal detector adapted for detection of dangerous metallic items carried by individuals, for example during access to a departure lounge in an airport, comprising a casing which houses a transmitter/receiver winding, the casing being extended by a gripping and handling handle, and a processor which feeds a loop of the winding to generate a magnetic field and which detects perturbations of the magnetic field caused by the environment, characterised in that the detector comprises a sensor for detecting orientation of the detector in a vertical position of the handle and which, when the detector is in a vertical position, activates a single dynamic detection mode of the winding whereas, when the detector is in another position, it activates a static operating mode of the winding.

### CROSS-REFERENCE TO RELATED APPLICATIONS

The present application is a continuation in part of U.S. patent application Ser. No. 14/451,799, filed on Aug. 5, 2014, which claims benefit to French Application No. 1357790, filed Aug. 5, 2013, the disclosures of which are incorporated herein by reference.

### FIELD OF THE INVENTION

The present invention relates to the field of portable metal detectors adapted for detection of dangerous metallic items carried by individuals, for example during access to a departure lounge in an airport, or any other similar place of controlled access.

### STATE OF THE ART

Many portable metal detectors have already been proposed adapted for detection of dangerous metallic items carried by individuals.

The attached FIG. 1 illustrates by way of non-limiting example the general structure of such known sensors.

As is evident from the attached FIGS. 1 and 2, known sensors 10 generally comprise a casing 20 extended by a gripping and handling handle 30.

The casing 20 contains an electric winding 22 in the form of a loop centred about an axis 23 which extends perpendicularly to the longitudinal direction 32 of the handle 30. The winding 22 is connected to a processor 40 and a power supply 42.

The processor 40 is adapted alternatively for a) feeding the winding 22, forming a transmitter winding by electrical voltage producing a magnetic field and b) detecting, as the winding 22 forms a receiver winding, perturbations of the magnetic field resulting from metallic pieces placed in the environment of the detector.

Known sensors can form the subject of many embodiments, especially as to the geometry of the winding, the nature of the electrical voltage applied to the winding (most often high-frequency alternative electrical voltage, and preferably successively frequency scanning), and the configuration of the winding 22 (a single winding can be provided, used alternatively and sequentially at the transmitter when supplied to generate a magnetic field and at the receiver when used to detect perturbations due to the environment or at least two separate windings respectively forming transmitter and receiver). As illustrated schematically in the attached FIG. 3, portable metal detectors 10 adapted for detection of dangerous metallic items carried by an individual are most often used by a security agent SA for body-scanning a suspect individual SI, for example in airports at the access to the departure lounge, after passing through a metal-detector gantry which has indicated the possible presence of a metal object on a suspect individual SI.

### GENERAL AIM OF THE INVENTION

Based on the observation that a conventional detector is highly sensitive to the environment, especially to concrete rebar forming the supporting floor, when it is used at foot level of a suspect individual to verify that this individual is not hiding a dangerous object, for example a knife, in his shoes or socks, as shown in FIG. 4, the aim of the present invention now is to propose means for eliminating drawback.

This aim is attained according to the invention by a portable metal detector adapted for detection of dangerous metallic items carried by individuals, comprising a casing which houses a transmitter winding and a receiver winding, the casing including a gripping and handling handle and a processor which feeds a loop of the transmitter winding to generate a magnetic field and which is connected to the receiver winding to detect perturbations of the magnetic field caused by the environment on the basis of the electrical signal issued from the receiver winding, wherein the detector comprises a sensor which detects orientation of the detector in a vertical position of the handle and which, when the detector is in a vertical position, activates a first dynamic detection mode of the winding wherein the processor detects only the perturbations which are not constant over a defined time range and ignores the perturbations detected which remain constant over a defined time range, whereas when the detector is in another position than the vertical, it activates a second static operating mode of the winding wherein all constant perturbations and non-constant perturbations are detected.

### DESCRIPTION OF FIGURES

Other characteristics, aims and advantages of the present invention will emerge from the following detailed description in relation to the attached diagrams given by way of non-limiting examples and in which:

FIGS. 1 to 4 mentioned previously schematically illustrate a known portable detector and its use,

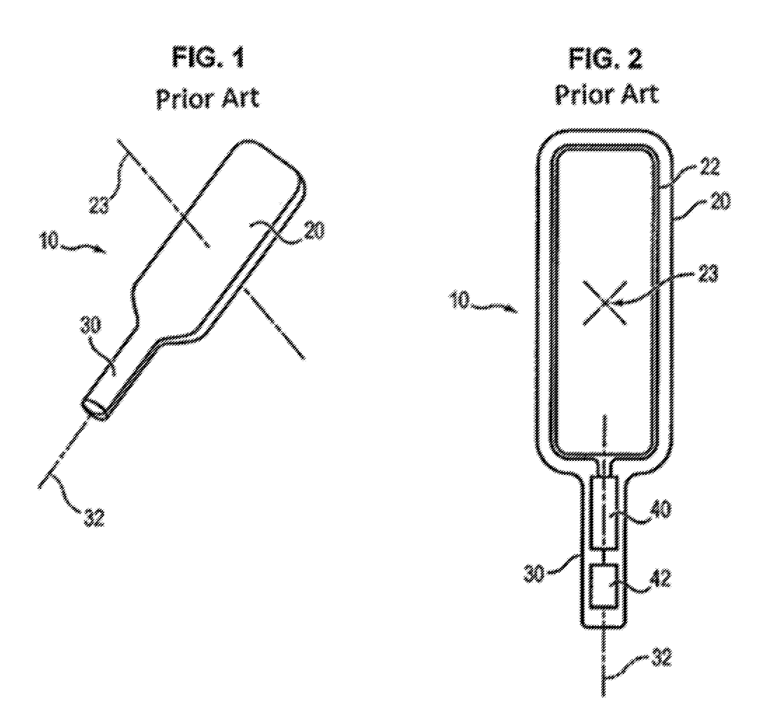

FIG. 5 schematically illustrates a non-limiting example of a portable detector according to the present invention,

FIG. 6 schematically illustrates a variant embodiment of the winding according to the present invention,

FIG. 7 schematically illustrates the electric and electronic means of a portable detector according to the present invention,

FIG. 8 schematically illustrates the operation of the portable detector according to the present invention.

### DETAILED DESCRIPTION

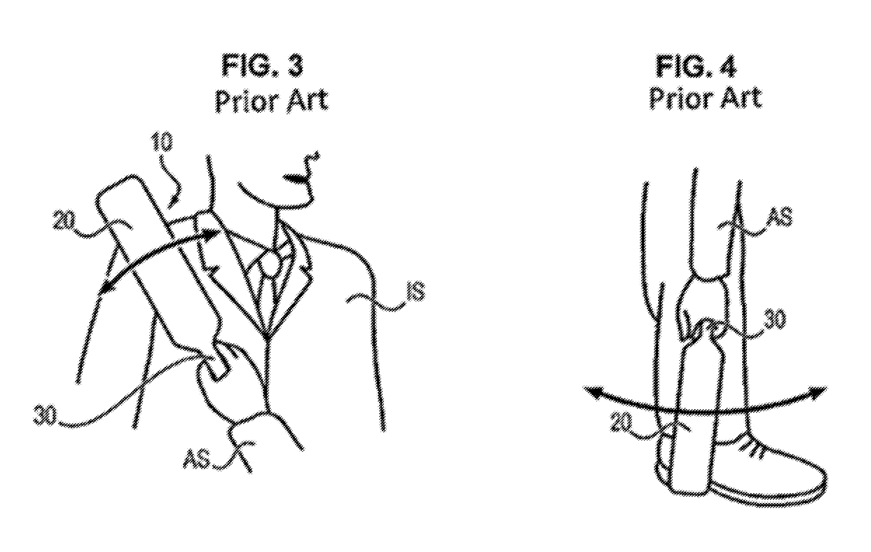

FIG. 5 schematically illustrates a sensor 100 according to the present invention comprising a casing 120 extended by a gripping and handling handle 130 which extends according to a longitudinal axis 132.

The casing 120 contains an electric winding 122.

The winding 122 is connected to a processor 140 and a power supply 142.

The processor 140 is adapted alternatively a) to feed the winding 122, forming a transmitter winding, by electrical voltage producing a magnetic field and b) detect, as the winding 122 forms a receiver winding, perturbations of the magnetic field resulting from metal pieces placed in the environment of the detector. That is, the detections received by the winding due to perturbations of the magnetic field are passed to the processor 140.

The winding 122 is preferably located in the median plane of the casing 120 located in the extension of the axis 132 of the handle 130, and centred about an axis 123 which extends perpendicularly to the longitudinal direction 132 of the handle 130.

As indicated previously according to the present invention, the detector also comprises a sensor 150, such as for example a triple-axle accelerometer, for detecting orientation of the detector in a vertical position of the handle 130 and which, when the detector is in this vertical position, activates only a dynamic detection mode of the winding 122, whereas when the detector is in another position it activates a static and operating mode dynamic of the winding 122.

<<Orientation of the detector in a vertical position of the handle 130>> means at least substantially vertical orientation, for example 15° close to the longitudinal direction 132 of the handle 130.

When just the dynamic operation of the winding 122 is activated, the processor ignores the perturbations detected which remain constant over a defined time range, whether the detector is being held in a constant position or being moved. This arrangement according to the present invention ignores perturbations due to rebar in the support flooring, but does detect a metal object carried at floor level by an individual, for example a knife, when the detector is moved at foot level of an individual.

However when dynamic and static operation of the winding 122 is activated, the processor 140 takes into account all perturbations detected, the detector being considered as being far from the floor.

Typically when the dynamic operation of the winding 122 is activated the processor 140 ignores the perturbations detected which remain constant over a defined time range, whether the detector is being held in a constant position or being moved, by taking into account only the part of the electrical signal representative of perturbations which has a frequency above 2.5 Hz or equal to 2.5 Hz.

Rejection of the perturbations which remain constant over a defined time range, such as perturbations having a frequency less than 2.5 Hz, for contrarily operating only the perturbations which are not constant, such as the perturbations having a frequency above or equal to 2.5 Hz, could be made by a high pass filter having a frequency threshold at 2.5 Hz.

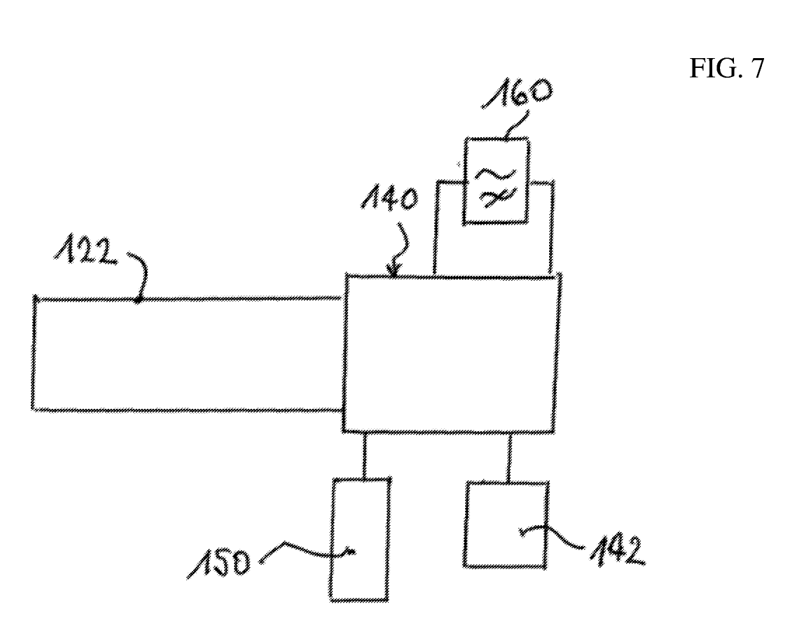

Such a high pass filter is illustrated on FIG. 7 under reference 160. FIG. 7 more precisely illustrates the winding 122, the processor 140, the power supply 142, the sensor 150 and the high pass filter 160.

When the sensor 150 detects that sensor 100 is in a vertical position, the processor 140 activates the first dynamic detection mode, so that the signal representative of the perturbations is passed through the high pass filter 160 and the processor 140 uses only the dynamic signal issued at the output of the high pass filter 160 and consequently the processor 140 detects only the perturbations which are not constant over a defined time range and ignores the perturbations detected which remain constant over a defined time range.

Contrarily when the sensor 150 detects that sensor 100 is not in a vertical position, the processor 140 activates the second static operating mode of the winding, so that the signal representative of the perturbations does not pass through the high pass filter 160 and the processor 140 uses consequently all constant perturbations and non-constant perturbations.

The processor 140 operates to feed the winding 122 and successively perform detection. The processor 140 may be any kind of digital processor, like a microprocessor, or an analog circuit device adapted to analyze the electrical signal issued by the receiver winding to detect any change in this electrical signal compared to the electrical signal issued by the receiver winding at rest when the detector is at distance of any metal object, corresponding to a perturbation of the magnetic field generated by the transmitter winding by a metal object. In the first dynamic detection mode, the processor 140 analyzes only the part of the perturbations signal having a frequency above a threshold, for example above 2.5 Hz. In the second static operating mode the processor 140 analyses all the components of the perturbations signal, i.e. the constant perturbations and the non-constant perturbations.

The position sensors formed by a triple-axle accelerometer are known per se. They will therefore not be described in any more detail hereinbelow.

Of course, the present invention is not limited to the embodiments which just been described, but extends to all variants in keeping with its central idea.

In particular, the geometry of the winding 122 can form the object of many variant embodiments.

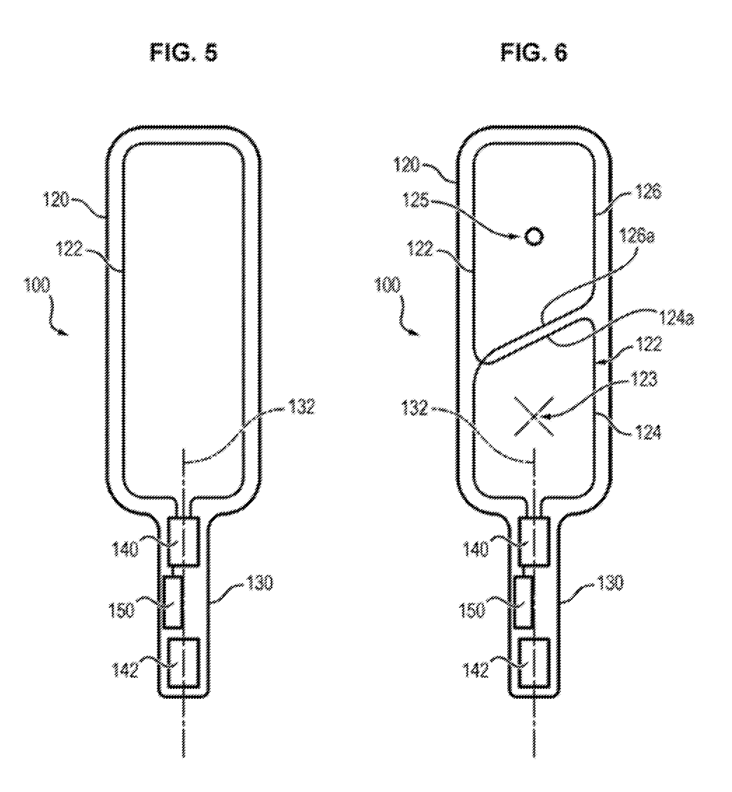

FIG. 6 illustrates a variant embodiment according to which the winding 122 comprises a multipolar winding in 8.

This multipolar winding 122 comprises two elementary loops 124 and 126 placed electrically in series and wound in opposite directions such that identical perturbations caused simultaneously on each elementary coil are compensated and cancelled at the output of the winding 122. The loops 124 and 126 are centred about respective axes 123, 125.

The number of turns of the two elementary loops 124 and 126 is preferably identical. Similarly, the surfaces of both elementary loops 124 and 126 are preferably identical.

Preferably, as is evident from FIG. 6, the adjacent strands 124a, 126a of the two elementary loops 124 and 126 of the winding 122, located in the median part of the winding in 8, do not extend orthogonally to the longitudinal direction 132 of the handle 130, but are inclined relative to this direction, so as not to create a neutral median zone on the magnetic plane at the level of which a metal object would not be detected. Because of the inclination of these strands 124a and 126a, it is actually guaranteed that an object placed near the middle of the winding 122 cuts field lines of the elementary coils 124, 126 when the detector is moved by scanning in an alternative pivoting movement centred about an axis centred overall on the wrist of the user and orthogonal to the direction 132.

In an embodiment, the winding 122 or inductive transducer is formed by a simple winding constituting transmitter and receiver.

In another embodiment, the transducer 122 is formed by two windings forming respectively transmitter and receiver, and is appropriate alternatively.

In all cases, the windings preferably comprise several loops in series of inverse directions for neutralising the effects of external parasites.

Also, the inductive transducer 122 can advantageously comprise windings offset to each other, both at the level of transmission and reception, to limit mutual inductance generated by the windings of the inductive transducer.

Of course, the number of transmitter windings and the number of receiver windings is not limited to one or two. Also, the number of transmitter windings is not necessarily identical to the number of receiver windings.

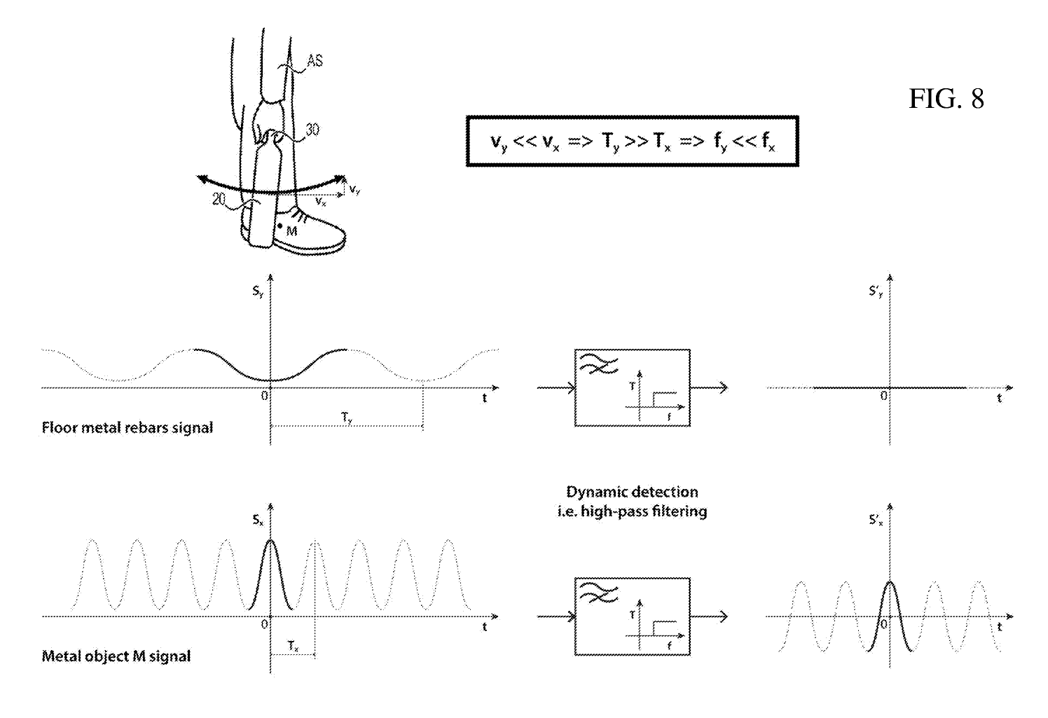

FIG. 8 explains how the signal generated by the concrete rebar in the floor is canceled with the present invention due to the switch of the detector in the dynamic mode using a high-pass filter 160 when the detector is displaced as illustrated on FIG. 4.

Considering:

Sy as the variation of the detection signal due to the variation of distance between the detector and the floor during displacement of the detector (when rebars are embedded in the concrete floor),

Sx the variation of the detection signal due to metallic object M (for example a knife) to identify located in a shoe,

the vertical displacement speed Vy is lower than the horizontal displacement speed Vx.

Moreover the mass M is confined on a limited area, while the metal in the floor extends along a great area in the floor. As a consequence the oscillation period Ty due to the floor metal rebars is greater than the oscillation period Tx due to the metal object M and the corresponding frequency Fy is lower to the frequency Fx.

In other words : Vy<<Vx, thus Ty>>Tx and fy<<fx.

When the detector 100 is in the vertical position, the dynamic mode allows to cancel, with the high-pass filter 160, the part of the signal having a low frequency Ty due to the floor metal rebars. This is illustrated on FIG. 8 wherein the graph Sy illustrates the perturbation signal due to the floor metal rebars at the input of the high pass filter 160 while the graph S′y illustrates the corresponding signal at the output of the high pass filter 160.

But in the dynamic mode the perturbation signal due to a metal object M which is not constant is taken into account by the processor 140. This is also illustrated on FIG. 8 wherein the graph Sx illustrates the perturbation signal due to the metal object M at the input of the high pass filter 160 while the graph S′x illustrates the corresponding signal due to the metal object M at the output of the high pass filter 160.

When the detector 100 is not in the vertical position, the static mode allows contrarily to analyze all the components of the detected signal.

1. A portable metal detector adapted for detection of dangerous metallic items carried by individuals, comprising a casing which houses a winding forming a transmitter winding and a receiver winding, the casing including a gripping and handling handle, and a processor which feeds a loop of the transmitter winding to generate a magnetic field and which is connected to the receiver winding to detect perturbations of the magnetic field caused by an environment on the basis of the electrical signal issued from the receiver winding, wherein the detector comprises a sensor which detects orientation of the detector in a vertical position of the handle and which, when the detector is in a vertical position, activates a first mode wherein the processor detects only the perturbations which are not constant over a defined time range and ignores the perturbations detected which remain constant over a defined time range, whereas when the detector is in another position than the vertical position, it activates a second mode wherein all constant perturbations and non-constant perturbations are detected.

2. The detector according to claim 1, wherein the sensor is a triple-axle accelerometer.

3. The detector according to claim 1, wherein the winding comprises a multipolar winding.

4. The detector according to claim 1, wherein the winding comprises two elementary loops placed electrically in series and wound in opposite directions such that identical perturbations caused simultaneously on each elementary loop are compensated and cancelled at the output of the winding.

5. The detector according to claim 1, further comprising a high pass filter to block the perturbations detected which remain constant over a defined time range.

6. The detector according to claim 5, wherein said high pass filter has a frequency threshold of about 2.5 Hz.

7. A portable metal detector adapted for detection of dangerous metallic items carried by individuals, comprising:
a casing including a handle;
a winding housed within the casing;
a processor which feeds a loop of the winding to generate a magnetic field; and
a sensor which detects orientation of the detector in a vertical position of the handle,
wherein the winding detects perturbations of the magnetic field caused by an environment and provides a corresponding electrical signal to the processor, and
wherein, when the detector is in a vertical position, the processor activates a first mode in which the winding ignores the perturbations detected which remain constant over a defined time range.

8. The detector according to claim 7, wherein, when the detector is in another position than the vertical position, the processor activates a second mode in which all perturbations are detected.

9. The detector according to claim 7, wherein the sensor is a triple-axle accelerometer.

10. The detector according to claim 7, wherein the winding comprises a multipolar winding.

11. The detector according to claim 7, wherein the winding comprises two elementary loops placed electrically in series and wound in opposite directions such that identical perturbations caused simultaneously on each elementary loop are compensated and cancelled at the output of the winding.

12. The detector according to claim 7, further comprising a high pass filter to block the perturbations detected which remain constant over a defined time range.

13. The detector according to claim 12, wherein said high pass filter has a frequency threshold of about 2.5 Hz.

14. A method of using a portable metal detector for detection of dangerous metallic items carried by individuals, comprising:
moving the detector around a portion of an individual, the detector including a casing including a handle, a winding housed within the casing, a processor which feeds a loop of the winding to generate a magnetic field, and a sensor which detects orientation of the detector in a vertical position of the handle, such that winding can detect perturbations of the magnetic field caused by an environment and can provide a corresponding electrical signal to the processor; and
moving the detector in a vertical position wherein the processor activates a first mode in which the winding ignores the perturbations detected which remain constant over a defined time range.

15. The method according to claim 14, wherein the step of moving the detector around a portion of an individual includes moving the detector in another position than the vertical position wherein the processor activates a second mode in which all perturbations are detected.

16. The method according to claim 14, wherein the sensor is a triple-axle accelerometer.

17. The method according to claim 14, wherein the winding comprises a multipolar winding.

18. The method according to claim 14, wherein the winding comprises two elementary loops placed electrically in series and wound in opposite directions such that identical perturbations caused simultaneously on each elementary loop are compensated and cancelled at the output of the winding.

19. The method according to claim 14, wherein the step of moving the detector in a vertical position includes operating a high pass filter of the detector to block the perturbations detected which remain constant over a defined time range.

20. The method according to claim 19, wherein the step of operating the high pass filter includes ignoring signals having a frequency less than about 2.5 Hz.

21. A portable metal detector adapted for detection of dangerous metallic items carried by individuals, comprising a casing which houses a winding forming a transmitter winding and a receiver winding, the casing including a gripping and handling handle, and a processor which feeds a loop of the transmitter winding to generate a magnetic field and which is connected to the receiver winding to detect perturbations of the magnetic field caused by an environment on the basis of the electrical signal issued from the receiver winding, wherein the detector comprises a sensor which detects orientation of the detector in a vertical position of the handle and which, when the detector is in a vertical position, activates a mode wherein the processor passes the received signal through a high-pass filter, therefore detects only the perturbations which are not constant over a defined time range and ignores the perturbations detected which remain constant over a defined time range.
